(19) United States
(12) Patent Application Publication
(10) Pub. No.: US 2024/0187493 A1
(43) Pub. Date: Jun. 6, 2024

(54) Intelligent Timeout Prediction in a Chain of Microservices Corresponding to a Service Mesh

(71) Applicant: International Business Machines Corporation, Armonk, NY (US)

(72) Inventors: Sudheesh S. Kairali, Koshikode (IN); Vijay Kalangumvathakkal, Pathanamthitta (IN); Ashish Kumar Thakur, Asansol (IN); Jagdish Kumar, Pune (IN); Sarbajit K. Rakshit, Kolkata (IN)

(21) Appl. No.: 18/061,573

(22) Filed: Dec. 5, 2022

(51) Int. Cl. H04L 67/51; G06F 9/50; G06F 11/07

(52) U.S. Cl. CPC H04L 67/51; G06F 9/5072; G06F 11/0757; G06F 2201/81

(57) ABSTRACT

Intelligent microservice timeout management is provided. It is determined whether a threshold level of predictability has been attained for a microservice chain corresponding to a current transaction requested by a user. It is determined whether the current transaction is predicted to result in a fast-forwarded façade timeout based on a total of historic execution times of microservices in the microservice chain for data size and data condition exceeding a total of configured timeouts of the microservices in the microservice chain in response to determining that the threshold level of predictability has been attained for the microservice chain. A timeout is presented at an entry point microservice into the microservice chain to terminate the current transaction prior to executing the microservice chain for the current transaction saving time and resources in response to determining that the current transaction is predicted to result in the fast-forwarded façade timeout.

### BACKGROUND

### 1. Field

The disclosure relates generally to a service mesh of microservices and more specifically to intelligent prediction of fast-forwarded facade and bulk timeouts in microservice chains corresponding to a service mesh in a container orchestration architecture of a cloud environment.

### 2. Description of the Related Art

A service mesh instruments a plurality of different microservices and directs communications traffic between the plurality of different microservices according to a predefined configuration. In other words, instead of configuring a running container, a system administrator can provide configuration to the service mesh and have the service mesh complete a transaction using the plurality of different microservices. The plurality of different microservices comprise a cloud-native application. The service mesh does not require any changes to the cloud-native application because the service mesh is located at the network level and uses a proxy for each microservice to intercept all network communication between the microservices. The service mesh connects, manages, and secures the plurality of different microservices in, for example, a container orchestration architecture such as Kubernetes® (a registered trademark of the Linux Foundation of San Francisco, California, U.S.A.). Each microservice in a microservice chain has a different functionality with downstream relationships. In other words, the microservice chain executes a sequence of functionalities to complete a transaction that corresponds to a service request submitted by a user via a client device.

### SUMMARY

According to one illustrative embodiment, a computer-implemented method for intelligent microservice timeout management is provided. One or more processors determine whether a threshold level of predictability has been attained for a microservice chain corresponding to a current transaction requested by a user. The one or more processors determine whether the current transaction is predicted to result in a fast-forwarded façade timeout based on a total of historic execution times of microservices in the microservice chain for data size and data condition exceeding a total of configured timeouts of the microservices in the microservice chain in response to the one or more processors determining that the threshold level of predictability has been attained for the microservice chain. The one or more processors present a timeout at an entry point microservice into the microservice chain to terminate the current transaction prior to executing the microservice chain for the current transaction saving time and resources in response to the one or more processors determining that the current transaction is predicted to result in the fast-forwarded façade timeout based on the total of historic execution times of the microservices in the microservice chain for the data size and the data condition exceeding the total of configured timeouts of the microservices in the microservice chain. According to other illustrative embodiments, a computer system and computer program product for intelligent microservice timeout management are provided.

### BRIEF DESCRIPTION OF THE DRAWINGS

FIG. 1 is a pictorial representation of a computing environment in which illustrative embodiments may be implemented;

FIG. 2 is a diagram illustrating an example of a microservice timeout management system in accordance with an illustrative embodiment; and

FIGS. 3A-3B are a flowchart illustrating a process for intelligent microservice timeout management in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

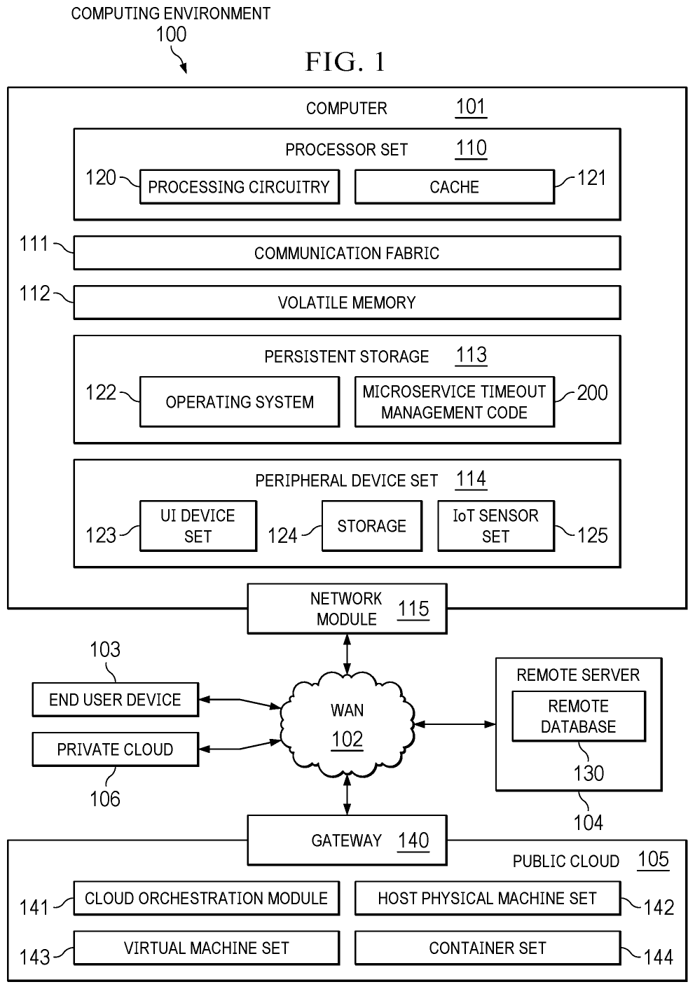

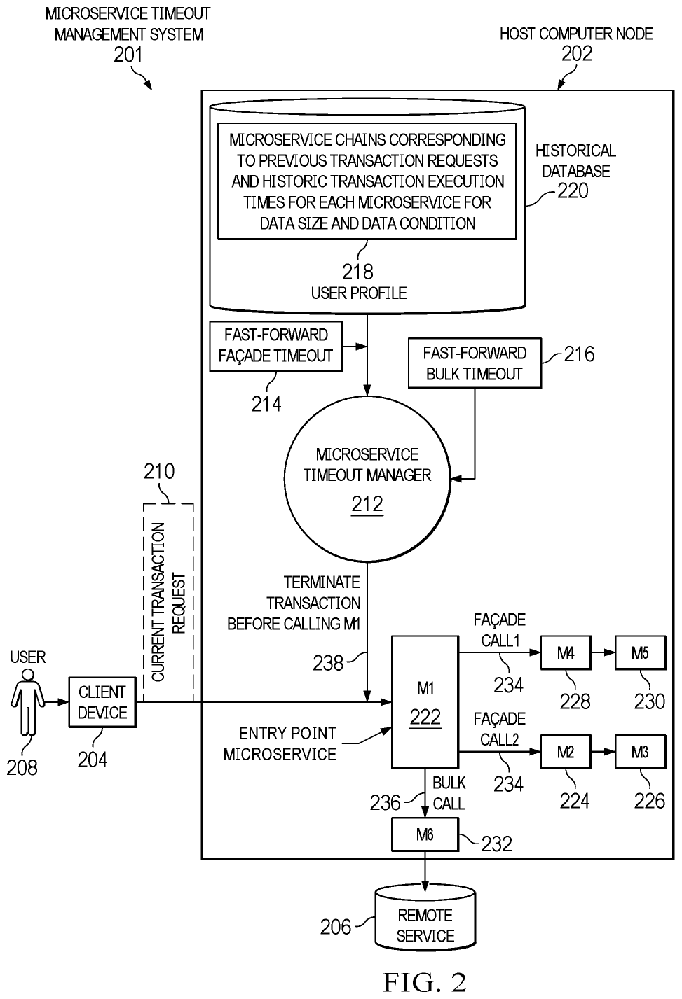

With reference now to the figures, and in particular, with reference to FIGS. 1-2, diagrams of data processing environments are provided in which illustrative embodiments may be implemented. It should be appreciated that FIGS. 1-2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods, such as microservice timeout management code 200. For example, microservice timeout management code 200 intelligently predicts timeouts in a set of microservice chains corresponding to a service mesh in advance of executing the set of microservice chains for a transaction to save time and resources.

In addition to microservice timeout management code block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and microservice timeout management code 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, mainframe computer, quantum computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in microservice timeout management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The microservice timeout management code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (for example, a customer of an entity that operates computer 101), and may take any of the forms discussed above in connection with computer 101. EUD 103 typically receives helpful and useful data from the operations of computer 101. For example, in a hypothetical case where computer 101 is designed to provide a transaction recommendation to an end user, this recommendation would typically be communicated from network module 115 of computer 101 through WAN 102 to EUD 103. In this way, EUD 103 can display, or otherwise present, the transaction recommendation to the end user. In some embodiments, EUD 103 may be a client device, such as thin client, heavy client, mainframe computer, desktop computer, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a microservice timeout recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity, such as, for example, an enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

A service mesh is an architecture that allows a chain of microservices to participate in completing a single transaction. One such microservice chain may be, for example: microservice (M)1→M2→M3→M4. In addition, one microservice (e.g., M1) can be included in multiple microservice chains. For example, M1→M2→M3 and M1→M4. In this example, if M3 times out (i.e., fails) or M4 times out, then M1 will also timeout. In some cases, M3 and M4 may together present a situation that times out the transaction. As per current solutions, the transaction will timeout in M1 only after the other microservices timeout. In other words, if the transaction times out at M3, then all the work previously performed by microservices M1 and M2 will need to be rolled back. Thus, a timeout at a downstream microservice in the microservice chain increases the roll back effort, which increases time and resource utilization and decreases system performance.

Illustrative embodiments predict in advance whether a microservice of a microservice chain will timeout. Based on this timeout prediction, illustrative embodiments present the timeout at the entry point microservice (e.g., M1) to the microservice chain in advance of actually processing the microservice chain. Thus, illustrative embodiments ensure that a predicted timeout (e.g., microservice failure) occurs at the earliest possible point in the microservice chain saving time and resources (e.g., processor, memory, network, and the like) and increasing system performance.

Illustrative embodiments identify a set of microservice chains of a service mesh, which is identified in a user profile of a user requesting a current transaction to be performed. Illustrative embodiments identify the user via a unique identifier and associate the user profile to the user utilizing the unique identifier of the user. The set of microservice chains corresponds to the current transaction being requested by the user. Illustrative embodiments also identify any timeout error that would be sent down a particular microservice chain by a given microservice. For example, in response to receiving a single API call to M1, illustrative embodiments identify the following set of microservice chains to be executed: M1→M3→M4 and M1→M5→M6. Preconfigured microservice time outs may be, for example, M1 times out at 30 seconds, M3 times out at 20 seconds, and the like.

While identifying the preconfigured timeout information corresponding to each respective microservice in the set of microservice chains corresponding to the transaction, illustrative embodiments further identify other information, such as for example, size of the data, condition of the data, and the like, corresponding to each respective microservice. Data size is the amount of data that a particular microservice needs to execute its portion of the transaction. Data condition is the type, state, form, or the like of the data that that particular microservice needs to execute its portion of the transaction. Illustrative embodiments may also identify the time and location of the transaction.

Illustrative embodiments utilize this identified information above to perform intelligent timeout predictions. In other words, illustrative embodiments are able to intelligently predict any possible timeouts for each entry into a set of microservice chains of a service mesh. Illustrative embodiments determine that a threshold level of predictability has been attained after illustrative embodiments have performed a predefined number of successful timeout predictions corresponding to that particular set of microservice chains of the service mesh.

Illustrative embodiments utilize a fast-forwarded facade call timeout in a microservice chain of the service mesh. For example, in response to receiving a single API call to an entry point microservice (e.g., M1) into the set of microservice chains corresponding to the transaction, illustrative embodiments predict whether a facade call results in a timeout in the set of microservice chains by adding together historic microservice execution times of all microservices in the set of microservice chains based on the data size and data condition needed by each particular microservice in the set of microservice chains to execute its portion of the transaction and determining whether a total of the historic microservice execution times exceeds a total of all configured timeouts of the microservices in the set of microservice chains. In response to illustrative embodiments predicting that the facade call does result in a timeout in the set of microservice chains, then illustrative embodiments do not call downstream microservices in the set of microservice chains, but instead present the timeout at the entry point microservice (e.g., M1), itself, to terminate the current transaction saving time and resources.

For example, in response to receiving the single API call to M1 corresponding to the transaction, illustrative embodiments identify the following set of microservice chains to be executed: M1→M3→M4 and M1→M5→M6. The configured time outs for the microservices are, for example, M1 times out at 30 seconds, M3 times out at 20 seconds, M4 times out at 15 seconds, M5 times out at 5 seconds, and M6 times out at 10 seconds. In response to illustrative embodiments predicting that M5 will timeout based on the data size and data condition needed by M5 to execute its portion of the transaction, illustrative embodiments timeout at M1, itself, instead of calling M5 and then M6, saving time and resources.

Illustrative embodiments also utilize a fast-forwarded bulk call timeout in a microservice chain of the service mesh. For example, in response to receiving a single API call to an entry point microservice (e.g., M1) into a microservice chain corresponding to the transaction, illustrative embodiments predict whether a bulk call results in a timeout in the microservice chain by adding together historic microservice execution times for each iteration through the microservice chain based on the data size and data condition needed by each particular microservice in the microservice chain to execute its portion of the transaction and determining whether a total of the historic microservice execution times exceeds a total of all configured timeouts of the microservices in the microservice chain. In response to illustrative embodiments predicting that the bulk call does result in a timeout in the microservice chain, illustrative embodiments do not call downstream microservices in the microservice chain, but instead present the timeout at the entry point microservice (e.g., M1), itself, to terminate the transaction saving time and resources.

For example, in response to receiving the single API call to M1 corresponding to the transaction, illustrative embodiments identify the following microservice chain to be executed: M1→M3→M4. Illustrative embodiments know that M3 calls M4, and M4 calls an external service such as a distributed database “N” number of times. The number of iterations depends upon the data size and the data condition. In response to illustrative embodiments predicting that M4 will timeout based on the data size and data condition needed by M4 to execute its portion of the transaction, illustrative embodiments timeout at M1, itself, instead of calling M3 and then M4, saving time and resources.

Illustrative embodiments also predict timeout errors early in the microservice chain by identifying any health issues of remote services (e.g., distributed database services, distributed in-memory database services, or the like). In response to illustrative embodiments predicting a timeout error in the microservice chain due to an identified health issue of a remote service called by a particular microservice in the microservice chain, illustrative embodiments execute a fast-forwarded timeout in the microservice chain and will not perform further processing.

For example, in response to receiving a single API call to M1 corresponding to the transaction, illustrative embodiments identify the following microservice chain to be executed: M1→M2→M3→M4→M5. In response to illustrative embodiments predicting that M5 will send a 504 Gateway Timeout Error to M4 due to a remote database service outage based on performing an analysis of historical information regarding execution of the transaction by that particular microservice chain, illustrative embodiments timeout at M1 based on the predicted gateway timeout error at M5. As a result, illustrative embodiments will terminate the current transaction at M1. In other words, illustrative embodiments send the predicted gateway timeout error back to M1.

Illustrative embodiments can be implemented in a service mesh-based platform, such as, for example, ISTIO® (a registered trademark of the Open Usage Commons Foundation of Seattle, Washington, U.S.A.). However, it should be noted that ISTIO is intended as an example only and not as a limitation on illustrative embodiments. In other words, illustrative embodiments can be implemented in any service mesh-based platform.

Illustrative embodiments track and record all possible microservice chains per user profile and API calls. A user profile includes, for example, unique identifier of the user, list of transactions previously requested by the user, list of transaction chains that correspond to the previously requested transactions, timestamps corresponding to the transactions, locations of the transactions, and the like. Illustrative embodiments also track and record all the data sizes and data conditions that correspond to the historic execution time of each respective microservice in a particular microservice chain. In addition, illustrative embodiments also store and know all of the configured timeouts of all of the microservices in a particular microservice chain.

Based on illustrative embodiments performing a historical analysis of a particular microservice chain corresponding to a user-requested transaction, illustrative embodiments detect whether the user-requested transaction corresponds to a façade call (i.e., a single API call that invokes multiple microservice chains (e.g., M1→M3→M4 and M1→M5→M6) from a single entry point microservice (e.g., M1)) or a bulk call (i.e., a single API call that invokes the same microservice chain (e.g., M1→M2→M3→M4→M5) multiple times due to at least one of data size or data condition). In response to illustrative embodiments detecting either a façade call invoking a plurality of microservice chains from an API call to a single entry point microservice or a bulk call invoking the same microservice chain a plurality of times from an API call to a single entry point microservice, illustrative embodiments predict whether a timeout will result in a particular microservice based on the data size and data condition needed for that particular microservice to execute its portion of the transaction. It should be noted that for an initial number of iterations, illustrative embodiments may not use the timeout prediction until illustrative embodiments have attained a threshold level of predictability after performing a predefined number of successful timeout predictions for that particular service mesh. During the initial number of iterations, illustrative embodiments will utilize standard or traditional microservice timeout processing if needed for the transaction.

When illustrative embodiments attain the threshold level of predictability, illustrative embodiments utilize a predicted timeout of a particular microservice in a microservice chain to time out the microservice chain prior to the microservice, which is predicted to timeout, calling a downstream microservice in that particular microservice chain. As a result, when illustrative embodiments pre-terminate execution of the transaction corresponding to that particular microservice chain based on the predicted time out of that particular microservice, illustrative embodiments enable the user to either retry the transaction sooner or change the data conditions corresponding to the transaction. As a result, illustrative embodiments reduce the effort needed to perform roll back of the transaction as illustrative embodiments time out the transaction at the entry point microservice into the microservice chain saving time and resources.

Thus, illustrative embodiments provide one or more technical solutions that overcome a technical problem with waiting until a downstream microservice in a microservice chain times out to terminate a transaction wasting time and resources and decreasing system performance. As a result, these one or more technical solutions provide a technical effect and practical application in the field of microservice chains.

With reference now to FIG. 2, a diagram illustrating an example of a microservice timeout management system is depicted in accordance with an illustrative embodiment. Microservice timeout management system 201 may be implemented in a computing environment, such as computing environment 100 in FIG. 1. Microservice timeout management system 201 is a system of hardware and software components for intelligently predicting fast-forwarded facade and bulk timeouts in microservice chains for transactions to decrease time and resource utilization and increase system performance.

In this example, microservice timeout management system 201 includes host computer node 202, client device 204, and remote service 206. Host computer node 202, client device 204, and remote service 206 may be, for example, computer 101, EUD 103, and remote database 130, respectively, in FIG. 1. However, it should be noted that microservice timeout management system 201 is intended to be an example only and not as a limitation on illustrative embodiments. For example, microservice timeout management system 201 can include any number of host computer nodes, client devices, remote services, and other devices and components not shown. In addition, microservice timeout management system 201 can be included in a container orchestration architecture within a cloud environment.

In this example, user 208 utilizes client device 204 to send current transaction request 210 to host computer node 202 via a network, such as, for example, WAN 102 in FIG. 1. Current transaction request 210 can correspond to any type of transaction, such as, for example, a banking transaction or the like, that user 208 is currently requesting to be performed. Host computer node 202 includes microservice timeout manager 212. Microservice timeout manager 212 can be implemented in microservice timeout management code 200 in FIG. 1.

Host computer node 202 utilizes microservice timeout manager 212 to predict whether the transaction corresponding to current transaction request 210 will result in fast-forwarded facade timeout 214 or fast-forwarded bulk timeout 216. Microservice timeout manager 212 predicts whether the transaction corresponding to current transaction request 210 results in fast-forwarded facade timeout 214 or fast-forwarded bulk timeout 216 based on information contained in user profile 218, which is stored in historical database 220. User profile 218 corresponds to user 208, who submitted current transaction request 210. Also, it should be noted that historical database 220 stores a plurality of different user profiles corresponding to a plurality of different users.

Microservice timeout manager 212 associates user 208 with user profile 218 using a unique identifier corresponding to user 208. Microservice timeout manager 212 retrieves the unique identifier corresponding to user 208 from data associated with current transaction request 210. User profile 218 contains information, such as, for example, user identifier, identification of microservice chains corresponding to previous transaction requests made by user 208, historic transaction execution times for each microservice based on data size and data condition, configured timeouts for each microservice, and the like. Microservice timeout manager 212 analyzes the information contained in user profile 218 to determine whether current transaction request 210 corresponds to one or more microservice chains.

In this example, the transaction corresponding to current transaction request 210 can either correspond microservice chains M1 222→M2 224→M3 226 and M1 222→M4 228→M5 230 or microservice chain M1 222→M6 232 depending on whether current transaction request 210 invokes facade call 234 or bulk call 236. It should be noted that M1 222 is the entry point microservice for each of the microservice chains in this example. Facade call 234 invokes a plurality of microservice chains (i.e., M1 222→M2 224→M3 226 and M1 222→M4 228→M5 230) from an API call to a single entry point microservice (i.e., M1 222). Bulk call 236 invokes the same microservice chain (i.e., M1 222→M6 232) a plurality of times from an API call to a single entry point microservice (i.e., M1 222) due to M6 232 calling remote service 206 multiple times due to the data size and the data condition needed by M6 232 to execute its portion of the transaction corresponding to current transaction request 210.

At 238, in response to microservice timeout manager 212 predicting that current transaction request 210 results in one of fast-forwarded facade timeout 214 or fast-forwarded bulk timeout 216, microservice timeout manager 212 terminates the transaction corresponding to current transaction request 210 before calling M1 222, which is the entry point microservice into the microservice chains, decreasing time and resource utilization and increasing performance of microservice timeout management system 201.

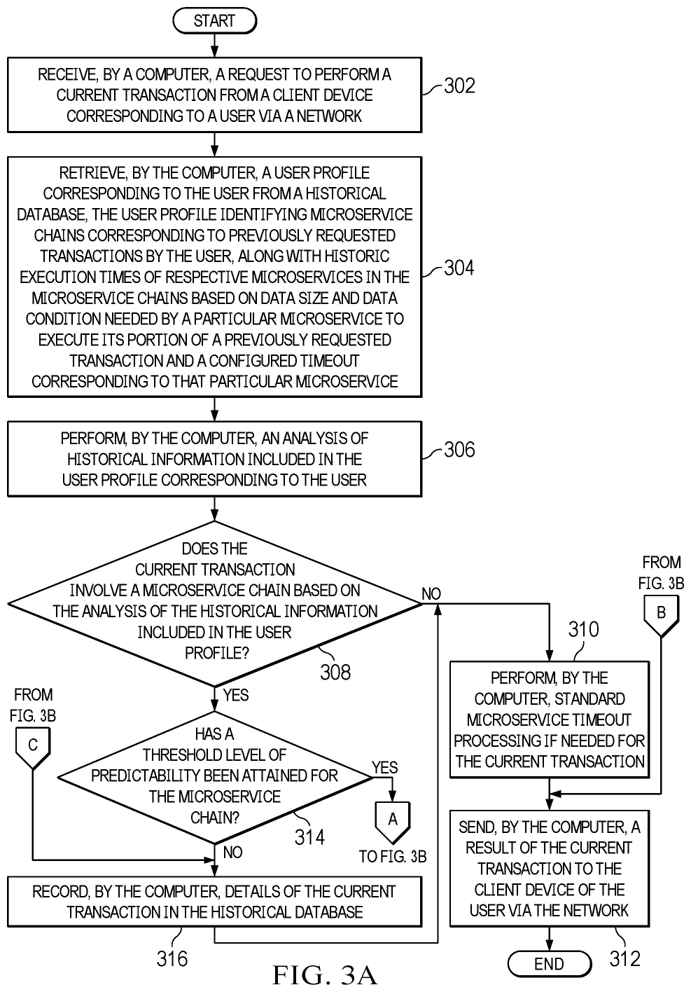

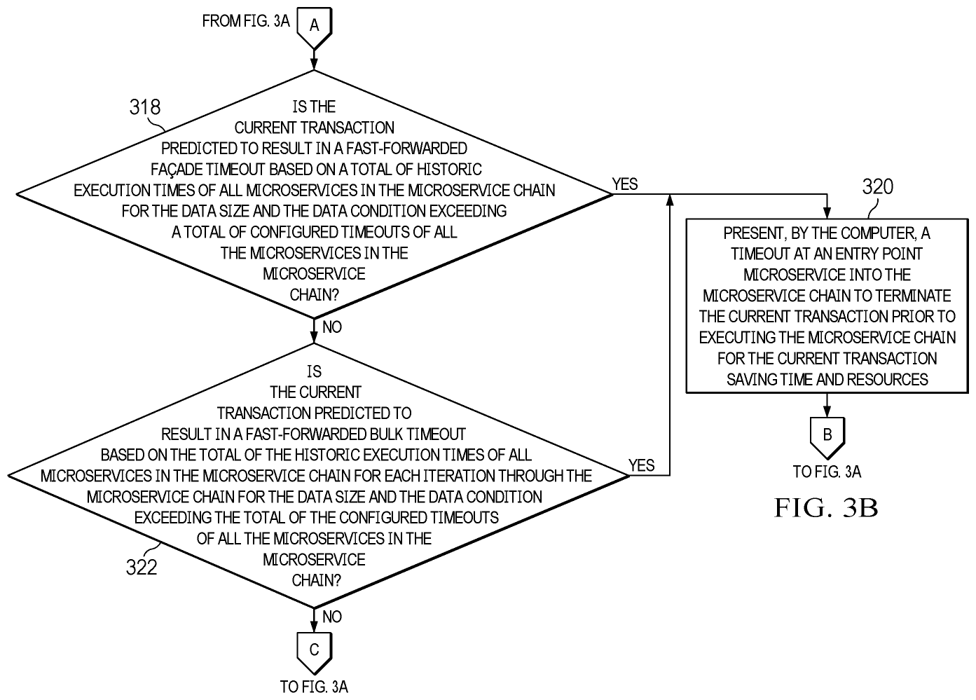

With reference now to FIGS. 3A-3B, a flowchart illustrating a process for . . . is shown in accordance with an illustrative embodiment. The process shown in FIGS. 3A-3B may be implemented in a computer, such as, for example, computer 101 in FIG. 1 or host computer node 202 in FIG. 2. For example, the process shown in FIGS. 3A-3B may be implemented in microservice timeout management code 200 in FIG. 1 or microservice timeout manager 212 in FIG. 2.

The process begins when the computer receives a request to perform a current transaction from a client device corresponding to a user via a network (step 302). In response to receiving the request to perform the current transaction, the computer retrieves a user profile corresponding to the user from a historical database (step 304). The user profile identifies microservice chains corresponding to previously requested transactions by the user, along with historic execution times of microservices in the microservice chains based on data size and data condition needed by a particular microservice to execute its portion of a previously requested transaction and a configured timeout corresponding to that particular microservice.

The computer performs an analysis of historical information included in the user profile corresponding to the user (step 306). The computer makes a determination as to whether the current transaction involves a microservice chain based on the analysis of the historical information included in the user profile (step 308). If the computer determines that the current transaction does not involve a microservice chain based on the analysis of the historical information included in the user profile, no output of step 308, then the computer performs standard microservice timeout processing if needed for the current transaction (step 310). Afterward, the computer sends a result of the transaction to the client device of the user via the network (step 312). The result is one of a completed transaction or a terminated transaction due to a microservice timeout. Thereafter, the process terminates.

Returning again to step 308, if the computer determines that the current transaction does involve a microservice chain based on the analysis of the historical information included in the user profile, yes output of step 308, then the computer makes a determination as to whether a threshold level of predictability has been attained for the microservice chain (step 314). The computer attains the threshold level of predictability after the computer performs a predefined number of successful timeout predictions for the microservice chain. If the computer determines that the threshold level of predictability has not been attained for the microservice chain, no output of step 314, then the computer records details of the current transaction in the historical database (step 316). Thereafter, the process returns to step 310 where the computer performs standard microservice timeout processing if needed for the current transaction.

Returning again to step 314, if the computer determines that the threshold level of predictability has been attained for the microservice chain, yes output of step 314, then the computer makes a determination as to whether the current transaction is predicted to result in a fast-forwarded façade timeout based on a total of historic execution times of all microservices in the microservice chain for the data size and the data condition exceeding a total of configured timeouts of all the microservices in the microservice chain (step 318). If the computer determines that the current transaction is predicted to result in a fast-forwarded façade timeout based on the total of historic execution times of all microservices in the microservice chain for the data size and the data condition exceeding the total of configured timeouts of all the microservices in the microservice chain, yes out of step 318, then the computer presents a timeout at an entry point microservice into the microservice chain to terminate the current transaction prior to executing the microservice chain for the current transaction saving time and resources (step 320). Thereafter, the process returns to step 312 where the computer sends the result of the current transaction to the client device of the user.

Returning again to step 318, if the computer determines that the current transaction is not predicted to result in a fast-forwarded façade timeout based on the total of historic execution times of all microservices in the microservice chain for the data size and the data condition not exceeding the total of configured timeouts of all the microservices in the microservice chain, no out of step 318, then the computer makes a determination as to whether the current transaction is predicted to result in a fast-forwarded bulk timeout based on the total of the historic execution times of all microservices in the microservice chain for each iteration through the microservice chain for the data size and the data condition exceeding the total of the configured timeouts of all the microservices in the microservice chain (step 322). If the computer determines that the current transaction is predicted to result in a fast-forwarded bulk timeout based on the total of the historic execution times of all microservices in the microservice chain for each iteration through the microservice chain for the data size and the data condition exceeding the total of the configured timeouts of all the microservices in the microservice chain, yes output of step 322, then the process returns to step 320 where the computer presents a timeout at the entry point microservice into the microservice chain. If the computer determines that the current transaction is not predicted to result in a fast-forwarded bulk timeout based on the total of the historic execution times of all microservices in the microservice chain for each iteration through the microservice chain for the data size and the data condition not exceeding the total of the configured timeouts of all the microservices in the microservice chain, no output of step 322, then the process returns to step 316 where the computer records details of the current transaction.

Thus, illustrative embodiments of the present invention provide a computer-implemented method, computer system, and computer program product for intelligently predicting fast-forwarded facade and bulk timeouts in microservice chains for transactions to decrease time and resource utilization. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for intelligent microservice timeout management, the computer-implemented method comprising:
determining, by one or more processors, whether a threshold level of predictability has been attained for a microservice chain corresponding to a current transaction requested by a user;
determining, by the one or more processors, whether the current transaction is predicted to result in a fast-forwarded façade timeout based on a total of historic execution times of microservices in the microservice chain for data size and data condition exceeding a total of configured timeouts of the microservices in the microservice chain in response to the one or more processors determining that the threshold level of predictability has been attained for the microservice chain; and
presenting, by the one or more processors, a timeout at an entry point microservice into the microservice chain to terminate the current transaction prior to executing the microservice chain for the current transaction saving time and resources in response to the one or more processors determining that the current transaction is predicted to result in the fast-forwarded façade timeout based on the total of historic execution times of the microservices in the microservice chain for the data size and the data condition exceeding the total of configured timeouts of the microservices in the microservice chain.

2. The computer-implemented method of claim 1, further comprising:
determining, by the one or more processors, whether the current transaction is predicted to result in a fast-forwarded bulk timeout based on the total of the historic execution times of the microservices in the microservice chain for each iteration through the microservice chain for the data size and the data condition exceeding the total of the configured timeouts of the microservices in the microservice chain in response to the one or more processors determining that the current transaction is not predicted to result in the fast-forwarded façade timeout based on the total of historic execution times of the microservices in the microservice chain for the data size and the data condition not exceeding the total of configured timeouts of the microservices in the microservice chain; and
presenting, by the one or more processors, the timeout at the entry point microservice into the microservice chain in response to the one or more processors determining that the current transaction is predicted to result in the fast-forwarded bulk timeout based on the total of the historic execution times of the microservices in the microservice chain for each iteration through the microservice chain for the data size and the data condition exceeding the total of the configured timeouts of the microservices in the microservice chain.

3. The computer-implemented method of claim 1, further comprising:
recording, by the one or more processors, details of the current transaction in a historical database in response to the one or more processors determining that the threshold level of predictability has not been attained for the microservice chain corresponding to the current transaction requested by the user;
performing, by the one or more processors, standard microservice timeout processing if needed for the current transaction; and
sending, by the one or more processors, a result of the current transaction to a client device of the user via a network.

4. The computer-implemented method of claim 1, further comprising:
receiving, by the one or more processors, a request to perform the current transaction from a client device corresponding to the user via a network; and
retrieving, by the one or more processors, a user profile corresponding to the user from a historical database, the user profile identifying microservice chains corresponding to previously requested transactions by the user, along with historic execution times of respective microservices in the microservice chains based on data size and data condition needed by a particular microservice to execute its portion of a previously requested transaction and a configured timeout corresponding to that particular microservice.

5. The computer-implemented method of claim 4, further comprising:
performing, by the one or more processors, an analysis of historical information included in the user profile corresponding to the user;
determining, by the one or more processors, whether the current transaction involves the microservice chain based on the analysis of the historical information included in the user profile; and
determining, by the one or more processors, whether the threshold level of predictability has been attained for the microservice chain in response to the one or more processors determining that the current transaction does involve the microservice chain based on the analysis of the historical information included in the user profile.

6. The computer-implemented method of claim 1, wherein the one or more processors attain the threshold level of predictability after the one or more processors perform a predefined number of successful timeout predictions for the microservice chain.

7. The computer-implemented method of claim 1, wherein the data size is an amount of data that a particular microservice needs to execute its portion of the current transaction and the data condition is a type, state, or form of the data that the particular microservice needs to execute its portion of the current transaction.

8. The computer-implemented method of claim 1, wherein the one or more processors are included in a container orchestration architecture within a cloud environment.

9. The computer-implemented method of claim 1, wherein the one or more processors predict timeout errors in the microservice chain by identifying health issues of remote services and execute a fast-forwarded timeout in the microservice chain in response to predicting a timeout error in the microservice chain due to an identified health issue of a remote service called by a particular microservice in the microservice chain.

10. A computer system for intelligent microservice timeout management, the computer system comprising:
a communication fabric;
a storage device connected to the communication fabric, wherein the storage device stores program instructions; and
one or more processors connected to the communication fabric, wherein the one or more processors execute the program instructions to:
determine whether a threshold level of predictability has been attained for a microservice chain corresponding to a current transaction requested by a user;
determine whether the current transaction is predicted to result in a fast-forwarded façade timeout based on a total of historic execution times of microservices in the microservice chain for data size and data condition exceeding a total of configured timeouts of the microservices in the microservice chain in response to determining that the threshold level of predictability has been attained for the microservice chain; and
present a timeout at an entry point microservice into the microservice chain to terminate the current transaction prior to executing the microservice chain for the current transaction saving time and resources in response to determining that the current transaction is predicted to result in the fast-forwarded façade timeout based on the total of historic execution times of the microservices in the microservice chain for the data size and the data condition exceeding the total of configured timeouts of the microservices in the microservice chain.

11. The computer system of claim 10, wherein the one or more processors further execute the program instructions to:
determine whether the current transaction is predicted to result in a fast-forwarded bulk timeout based on the total of the historic execution times of the microservices in the microservice chain for each iteration through the microservice chain for the data size and the data condition exceeding the total of the configured timeouts of the microservices in the microservice chain in response to determining that the current transaction is not predicted to result in the fast-forwarded façade timeout based on the total of historic execution times of the microservices in the microservice chain for the data size and the data condition not exceeding the total of configured timeouts of the microservices in the microservice chain; and
present the timeout at the entry point microservice into the microservice chain in response to determining that the current transaction is predicted to result in the fast-forwarded bulk timeout based on the total of the historic execution times of the microservices in the microservice chain for each iteration through the microservice chain for the data size and the data condition exceeding the total of the configured timeouts of the microservices in the microservice chain.

12. The computer system of claim 10, wherein the one or more processors further execute the program instructions to:
record details of the current transaction in a historical database in response to determining that the threshold level of predictability has not been attained for the microservice chain corresponding to the current transaction requested by the user;
perform standard microservice timeout processing if needed for the current transaction; and
send a result of the current transaction to a client device of the user via a network.

13. The computer system of claim 10, wherein the one or more processors further execute the program instructions to:
receive a request to perform the current transaction from a client device corresponding to the user via a network; and
retrieve a user profile corresponding to the user from a historical database, the user profile identifying microservice chains corresponding to previously requested transactions by the user, along with historic execution times of respective microservices in the microservice chains based on data size and data condition needed by a particular microservice to execute its portion of a previously requested transaction and a configured timeout corresponding to that particular microservice.

14. The computer system of claim 13, wherein the one or more processors further execute the program instructions to:
perform an analysis of historical information included in the user profile corresponding to the user;
determine whether the current transaction involves the microservice chain based on the analysis of the historical information included in the user profile; and
determine whether the threshold level of predictability has been attained for the microservice chain in response to determining that the current transaction does involve the microservice chain based on the analysis of the historical information included in the user profile.

15. A computer program product for intelligent microservice timeout management, the computer program product comprising a computer-readable storage medium having program instructions embodied therewith, the program instructions executable by one or more processors to cause the one or more processors to perform a method of:
determining, by the one or more processors, whether a threshold level of predictability has been attained for a microservice chain corresponding to a current transaction requested by a user;
determining, by the one or more processors, whether the current transaction is predicted to result in a fast-forwarded façade timeout based on a total of historic execution times of microservices in the microservice chain for data size and data condition exceeding a total of configured timeouts of the microservices in the microservice chain in response to the one or more processors determining that the threshold level of predictability has been attained for the microservice chain; and
presenting, by the one or more processors, a timeout at an entry point microservice into the microservice chain to terminate the current transaction prior to executing the microservice chain for the current transaction saving time and resources in response to the one or more processors determining that the current transaction is predicted to result in the fast-forwarded façade timeout based on the total of historic execution times of the microservices in the microservice chain for the data size and the data condition exceeding the total of configured timeouts of the microservices in the microservice chain.

16. The computer program product of claim 15, further comprising:
determining, by the one or more processors, whether the current transaction is predicted to result in a fast-forwarded bulk timeout based on the total of the historic execution times of the microservices in the microservice chain for each iteration through the microservice chain for the data size and the data condition exceeding the total of the configured timeouts of the microservices in the microservice chain in response to the one or more processors determining that the current transaction is not predicted to result in the fast-forwarded façade timeout based on the total of historic execution times of the microservices in the microservice chain for the data size and the data condition not exceeding the total of configured timeouts of the microservices in the microservice chain; and
presenting, by the one or more processors, the timeout at the entry point microservice into the microservice chain in response to the one or more processors determining that the current transaction is predicted to result in the fast-forwarded bulk timeout based on the total of the historic execution times of the microservices in the microservice chain for each iteration through the microservice chain for the data size and the data condition exceeding the total of the configured timeouts of the microservices in the microservice chain.

17. The computer program product of claim 15, further comprising:
recording, by the one or more processors, details of the current transaction in a historical database in response to the one or more processors determining that the threshold level of predictability has not been attained for the microservice chain corresponding to the current transaction requested by the user;
performing, by the one or more processors, standard microservice timeout processing if needed for the current transaction; and
sending, by the one or more processors, a result of the current transaction to a client device of the user via a network.

18. The computer program product of claim 15, further comprising:
receiving, by the one or more processors, a request to perform the current transaction from a client device corresponding to the user via a network; and
retrieving, by the one or more processors, a user profile corresponding to the user from a historical database, the user profile identifying microservice chains corresponding to previously requested transactions by the user, along with historic execution times of respective microservices in the microservice chains based on data size and data condition needed by a particular microservice to execute its portion of a previously requested transaction and a configured timeout corresponding to that particular microservice.

19. The computer program product of claim 18, further comprising:
performing, by the one or more processors, an analysis of historical information included in the user profile corresponding to the user;
determining, by the one or more processors, whether the current transaction involves the microservice chain based on the analysis of the historical information included in the user profile; and
determining, by the one or more processors, whether the threshold level of predictability has been attained for the microservice chain in response to the one or more processors determining that the current transaction does involve the microservice chain based on the analysis of the historical information included in the user profile.

20. The computer program product of claim 15, wherein the one or more processors attain the threshold level of predictability after the one or more processors perform a predefined number of successful timeout predictions for the microservice chain.
